(19) United States
(12) Patent Application Publication
(10) Pub. No.: US 2017/0241541 A1
(43) Pub. Date: Aug. 24, 2017

(54) REDUCER OF ELECTRONIC POWER STEERING APPARATUS

(71) Applicant: Mando Corporation, Pyeongtaek-si (KR)

(72) Inventor: Hyun Bi KWON, Yongin-si (KR)

(21) Appl. No.: 15/438,622

(22) Filed: Feb. 21, 2017

(30) Foreign Application Priority Data
Feb. 22, 2016 (KR) 10-2016-0020622

(51) Int. Cl. F16H 57/04; F16H 1/16; F16H 55/22; F16H 57/021; F16H 55/06; B62D 5/00; F16H 57/039

(52) U.S. Cl. CPC F16H 57/0498; B62D 5/008; F16H 1/16; F16H 57/0417; F16H 57/039; F16H 57/021; F16H 55/06; F16H 55/22; B62D 5/04

(57) ABSTRACT

Disclosed herein is a reducer for an electronic power steering apparatus, which includes a gear housing including a worm shaft housing and a worm wheel housing, the gear housing being made of a heat conductive material, a worm wheel shaft connected to a steering shaft to rotate along with rotation of the steering shaft, a worm wheel accommodated in the worm wheel housing, and having a first surface and a second surface facing the first surface, the worm wheel shaft being coupled to the worm wheel, a first heat transfer plate provided to come into contact with the first surface of the worm wheel, and a first bearing coupled to the worm wheel shaft to come into contact with the first heat transfer plate, and having an outer peripheral surface coming into contact with the worm wheel housing.

### CROSS-REFERENCE(S) TO RELATED APPLICATIONS

This application claims priority to Korean Patent Application No. 10-2016-0020622, filed on Feb. 22, 2016, the disclosure of which is incorporated herein by reference in its entirety.

### BACKGROUND OF THE INVENTION

Field of the Invention

Exemplary embodiments of the present invention relate to a reducer for an electronic power steering apparatus, and more particularly, to a reducer for an electronic power steering apparatus, which is capable of improving heat dissipation performance.

Description of the Related Art

FIG. 1 is a view illustrating a configuration of a typical electronic power steering apparatus.

Referring to FIG. 1, a typical electronic power steering apparatus 100 includes a steering wheel 102 placed in a driver seat, a steering shaft 106 connected to the steering wheel 102, a steering column 130 that enables the steering shaft 106 to be fixed to a vehicle body, a rack and pinion mechanism 110 that includes a rack gear and a pinion gear to convert the rotational force input from the steering shaft 106 into rectilinear motion, and a rack bar 112 that has a tie rod 122 and a knuckle arm 124 at both ends thereof.

The steering column 130 is configured such that the steering shaft 106 is connected at one side thereof to the steering wheel 102 to rotate along with the steering wheel 102 and the other side thereof is connected to a pinion shaft 108 through a pair of universal joints 104. The pinion shaft 108 is connected to the rack bar 112 through the rack and pinion mechanism 110, and both ends of the rack bar 112 are connected to vehicle wheels 126 through the tie rod 122 and the knuckle arm 124.

An auxiliary power device 140 includes a torque sensor 142 that detects a torque applied to the steering wheel 102 by a driver and outputs an electrical signal proportional to the detected torque, an ECU 144 that generates a control signal in response to the electrical signal transmitted from the torque sensor 142, a motor 146 that generates auxiliary power in response to the control signal transmitted from the ECU 144, and a reducer 150 that has a worm 152 and a worm wheel 156 to transmit the auxiliary power generated by the motor to the steering shaft 106.

Accordingly, the electronic power steering apparatus is configured such that the torque generated by the rotation of the steering wheel 102 is transmitted to the rack bar 112 via the rack and pinion mechanism 110 and the auxiliary power generated by the motor 146 according to the generated torque is transmitted to the rack bar 112.

That is, the torque generated by the rotation of the steering wheel 102 and the auxiliary power generated by the motor 146 are combined so that the rack bar 112 moves axially.

FIG. 2 is a cross-sectional view illustrating a reducer for an electronic power steering apparatus according to the related art.

Referring to FIG. 2, a conventional reducer 150 includes a worm shaft 254 having a worm 152 formed thereon and worm shaft bearings 257 that are respectively installed at both ends of the worm shaft 254 to support the worm shaft 254. In the reducer, a plug bolt 210 is fastened between a damping coupler 240 and an associated one of the worm shaft bearings 257 to prevent the worm shaft bearing 257 from moving in the axial direction of the worm shaft 254, and the plug bolt 210 is fixed by a plug nut 220.

The worm shaft 254 is connected to a motor 146 through the damping coupler 240 and is rotated by driving the motor 146.

A worm wheel 156 is provided at one side of the worm shaft 254 to engage with the worm 152 formed on the outer peripheral surface of the worm shaft 254. The worm wheel 156 is mounted to the steering shaft 106, which transmits the rotational force of the steering wheel 102 (see FIG. 1) operated by the driver, so as to transmit the rotational force of the worm shaft 254 by the driving of the motor 146 to the steering shaft 106.

The worm shaft 254 and the worm wheel 156 are accommodated in a gear housing 260, the motor 146 that supplies a driving force to the worm shaft 254 is provided at one side of the gear housing 260, and the gearing housing 260 and the motor 146 are coupled by a motor cover 230 with a bolt 250.

The reducer for an electronic power steering apparatus having the above structure serves to smoothly and stably maintain the steering operation state of the driver in such a manner that the driving of the motor is controlled by the ECU provided in the vehicle according to the traveling condition of the vehicle and the rotational force of the worm shaft by the driving of the motor is added to the rotational force of the steering wheel operated by the driver to be transmitted to the steering shaft.

That is, the conventional reducer for an electronic power steering apparatus assists a steering force by rotating the worm wheel, which is connected to the steering shaft, using the worm shaft.

However, the conventional electronic power steering apparatus uses the worm shaft and the worm wheel due to the characteristics thereof, and hence in case of steering the vehicle at a high speed, particularly as during parking to which a large load is applied, frictional heat may be generated due to contact between gear teeth while the worm shaft and the worm wheel rotate at a high speed according to the high-speed rotation of the motor that generates power for steering. For this reason, the conventional electronic power steering apparatus has a limited structure in which the heat generated by the worm shaft and the worm wheel accommodated in the gear housing is accumulated in the gear housing.

### PRIOR ART DOCUMENT

### Patent Document

(Patent Document) Korean Patent Application Publication No. 10-2006-0101622

### SUMMARY OF THE INVENTION

An object of the present invention is to provide a reducer for an electronic power steering apparatus, which is capable of smoothly dissipating frictional heat due to contact between gear teeth of a worm shaft and a worm wheel that rotate at a high speed when a power steering apparatus is driven in order to prevent deterioration of durability due to heat of gear teeth made of plastic material.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an aspect of the present invention, a reducer for an electronic power steering apparatus includes a gear housing including a worm shaft housing and a worm wheel housing, a worm wheel shaft connected to a steering shaft to rotate along with rotation of the steering shaft, a worm wheel accommodated in the worm wheel housing, and having a first surface and a second surface facing the first surface, the worm wheel shaft being coupled to the worm wheel, a first heat transfer plate provided to come into contact with the first surface of the worm wheel, and a first bearing coupled to the worm wheel shaft to come into contact with the first heat transfer plate, and having an outer peripheral surface coming into contact with the worm wheel housing.

The first heat transfer plate may have an axial hole through which the worm wheel shaft is coupled to the first heat transfer plate, and the first heat transfer plate may have a contact protrusion that is formed around the axial hole while protruding therefrom to come into contact with the first bearing.

The first heat transfer plate may have a plurality of vents radially arranged about the axial hole.

The first bearing may include an inner ring fastened to the worm wheel shaft and coming into contact with the contact protrusion of the first heat transfer plate, an outer ring spaced apart from the inner ring and coupled to the worm wheel housing, and a ball disposed between the inner ring and the outer ring.

The first heat transfer plate may have a plurality of tooth protrusions that are formed on an outer peripheral surface thereof so as to correspond to gear teeth of the worm wheel.

The reducer may further include a second heat transfer plate provided to come into contact with the second surface of the worm wheel, and a second bearing coupled to the worm wheel shaft to come into contact with the second heat transfer plate and having an outer peripheral surface coming into contact with the worm wheel housing.

The worm wheel may include a worm wheel body coupled with the worm wheel shaft, and a tooth portion formed on an outer peripheral surface of the worm wheel body, the tooth portion being formed with gear teeth so as to engage with a worm of a worm shaft.

The reducer may further include a plurality of heat transfer members interposed between the worm wheel body and the tooth portion, the heat transfer members coming into contact with the first heat transfer plate.

Each of the worm wheel body and the tooth portion may be made of an engineering plastic material.

It is to be understood that both the foregoing general description and the following detailed description of the present invention are exemplary and explanatory and are intended to provide further explanation of the invention as claimed.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view illustrating a configuration of a typical electronic power steering apparatus;

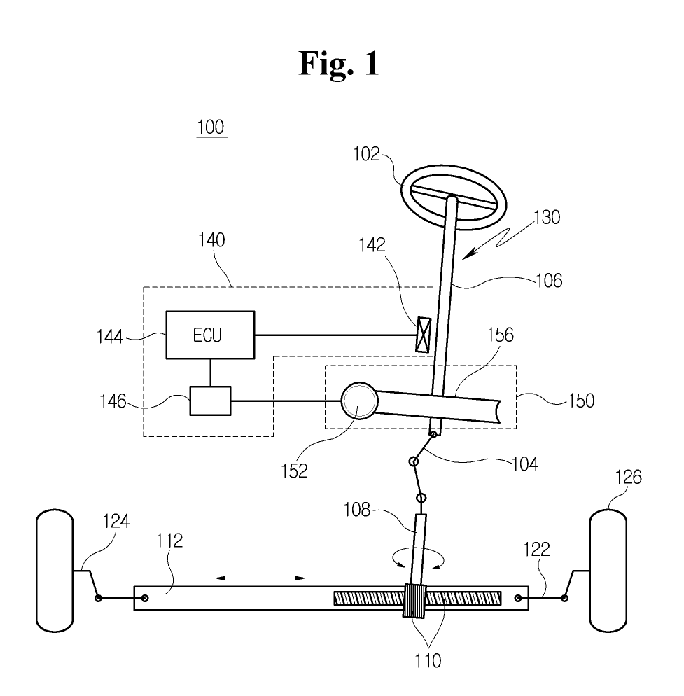

FIG. 2 is a cross-sectional view illustrating a reducer for an electronic power steering apparatus according to the related art;

FIG. 3 is an exploded perspective view illustrating a portion of a reducer for an electronic power steering apparatus according to an embodiment of the present invention;

FIG. 4 is an expanded detail view illustrating a portion of FIG. 3;

FIG. 5 is a side view illustrating a main portion of the reducer for an electronic power steering apparatus according to the embodiment of the present invention; and

FIG. 6 is an expanded detail view illustrating a portion of FIG. 5.

### DESCRIPTION OF SPECIFIC EMBODIMENTS

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

In the whole description, it will be understood that when an element is referred to as being “connected” to another element, it can be “directly connected” to the other element or it can be “electrically connected” to the other element with other elements being interposed therebetween. In addition, it will be understood that when a component is referred to as being “comprising” any component, it does not exclude other components, but can further comprises the other components unless otherwise specified.

Hereinafter, exemplary embodiments of the present invention will be described in detail with reference to the accompanying drawings.

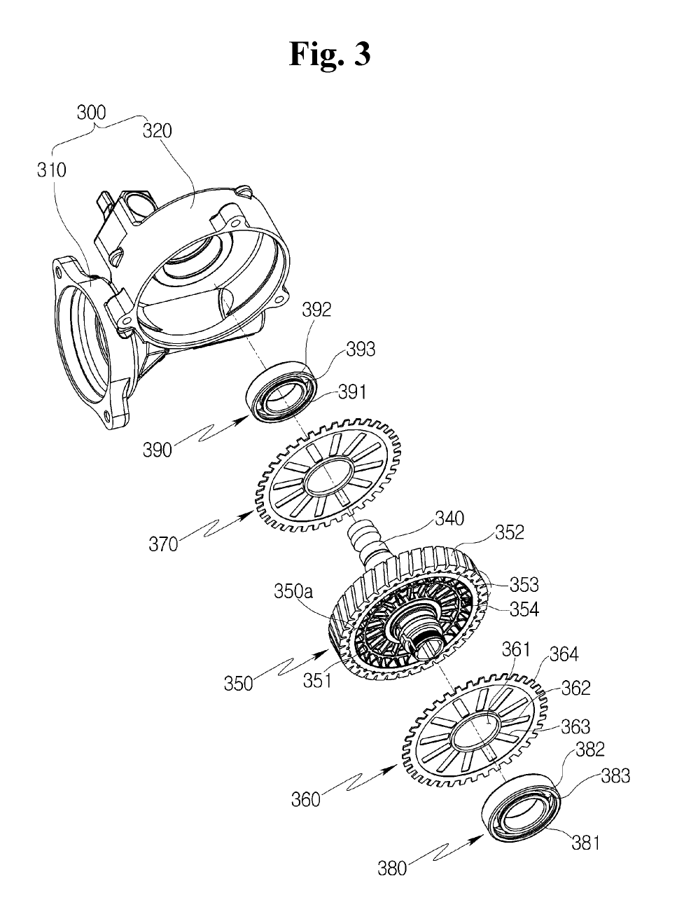

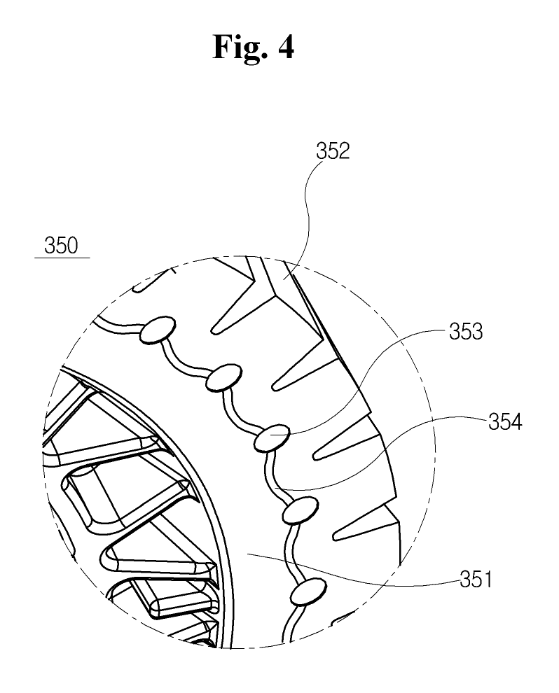

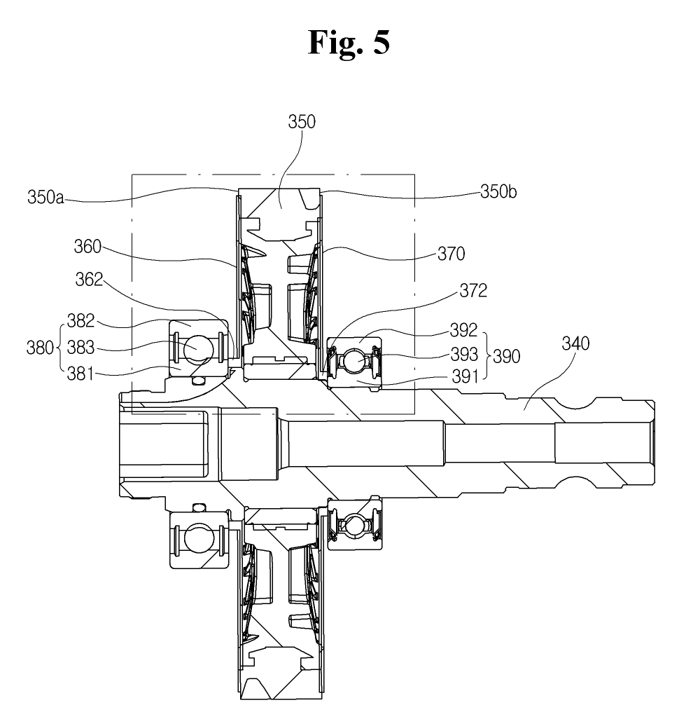

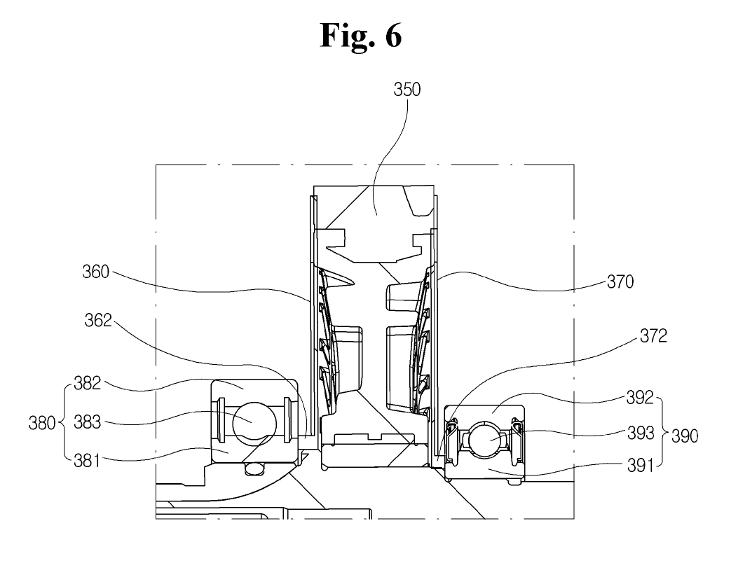

FIG. 3 is an exploded perspective view illustrating a portion of a reducer for an electronic power steering apparatus according to an embodiment of the present invention. FIG. 4 is an expanded detail view illustrating a portion of FIG. 3. FIG. 5 is a side view illustrating a main portion of the reducer for an electronic power steering apparatus according to the embodiment of the present invention. FIG. 6 is an expanded detail view illustrating a portion of FIG. 5.

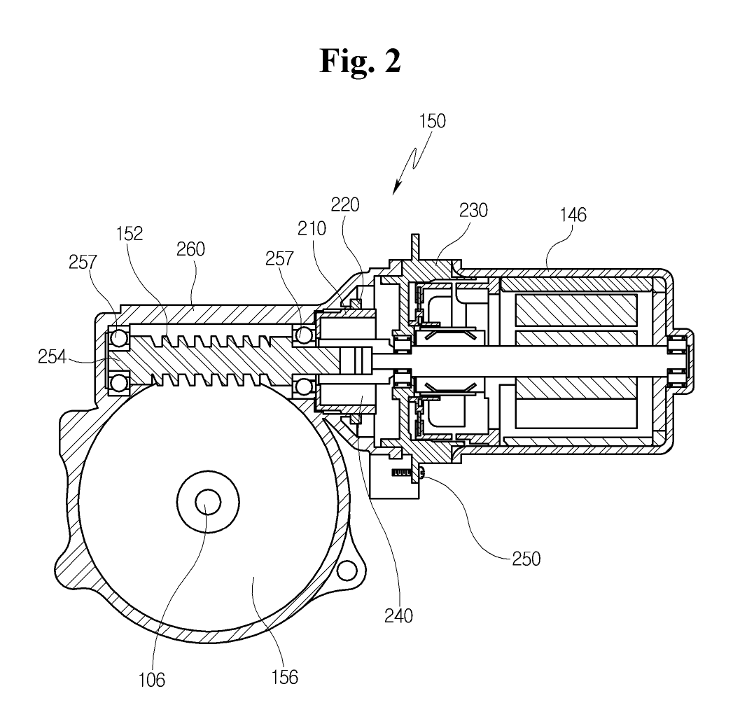

Referring to FIGS. 3 to 6, the reducer for an electronic power steering apparatus according to the embodiment of the present invention includes a gear housing 300, a worm shaft 254 (see FIG. 2), a worm wheel shaft 340, a worm wheel 350, and a first heat transfer plate 360.

The gear housing 300 may include a worm shaft housing 310 that accommodates the worm shaft, and a worm wheel housing 320 that accommodates the worm wheel 350. The gear housing 300 serves as a heat sink that radiates heat generated therein. Accordingly, the gear housing 300 may be made of a heat conductive material, particularly an aluminum (Al) material in order to reduce weight. In addition, the gear housing 300 may have a plurality of uneven portions that are formed on the surface thereof to increase a function as a heat sink.

The worm shaft is accommodated in the worm shaft housing 310, and is connected to a motor shaft (not shown), which is disposed at one side of the worm shaft housing 310, to rotate along with the motor shaft when a motor is driven. The worm shaft has a worm (not shown) that is formed on the outer peripheral surface thereof to engage with the worm wheel 350.

The worm wheel shaft 340 is connected to a steering shaft (not shown), which transmits the rotational force of a steering wheel, to rotate along with the rotation of the steering shaft. The worm wheel shaft 340 is press-fitted into an axial hole formed in the center of the worm wheel 350, and an end of the worm wheel shaft 340 protrudes out of the worm wheel housing 320.

The worm wheel 350 is accommodated in the worm wheel housing 320, and has a first surface 350a and a second surface 350b that faces the first surface 350a. The worm wheel 350 has a worm wheel body 351 to which the worm wheel shaft 340 is coupled. The axial hole is formed in the center of the worm wheel body 351 so that the worm wheel shaft 340 is press-fitted to the worm wheel body 351 through the axial hole, and the worm wheel 350 integrally rotates when the worm wheel shaft 340 rotates. The worm wheel body 351 has a tooth portion 352 formed on the outer peripheral surface thereof, and the tooth portion 352 is formed with gear teeth so as to engage with the worm of the worm shaft. The tooth portion 352 may be formed on the outer periphery of the worm wheel body 351 by insert injection molding or the like. The worm wheel body 351 may be made of steel or an engineering plastic material, and the tooth portion 352 with the gear teeth may be made of an engineering plastic material.

In this case, a plurality of heat transfer members 353 made of a heat conductive material may be interposed at regular intervals between the worm wheel body 351 and the tooth portion 352. Although the heat transfer members 353 may each have a cylindrical or polygonal column shape, the present invention is not limited thereto. Both ends of each of the heat transfer members 353 come into contact with at least one of the first heat transfer plate 360 and a second heat transfer plate 370 to be described later, and the heat transfer members 353 transfer rapidly heat generated by the worm wheel 350 during the rotation thereof to the first or second heat transfer plate 360 or 370. The heat transfer members 353 may be connected to each other using ring-shaped connection members 354, and the heat transfer members 353 interconnected by the connection members 354 may be easily assembled between the worm wheel body 351 and the tooth portion 352. Also, the connection members 354 may each be made of a heat conductive material, similar to the heat transfer members 353.

The first heat transfer plate 360 has a substantially disk shape, and has an axial hole 361 formed in the center thereof so that the worm wheel shaft 340 is inserted into the axial hole 361 to be coupled to the first heat transfer plate 360. The first heat transfer plate 360 is disposed between the worm wheel 350 and a first bearing 380. That is, the first heat transfer plate 360 comes into contact with the first surface 350a of the worm wheel 350 to transfer heat generated by the worm wheel 350 to the first bearing 380. The first heat transfer plate 360 is made of a heat conductive material, e.g. a metal material, and may be integrally formed on the first surface 350a of the worm wheel 350 by insert injection molding or the like.

The first heat transfer plate 360 may have a contact protrusion 362 that is formed on one surface thereof to come into contact with an inner ring of the first bearing 380. For example, the contact protrusion 362 may be formed throughout the circumference of the axial hole 361 while protruding therefrom, so as to maximize a contact area with the inner ring of the first bearing 380. The first heat transfer plate 360 may have a plurality of vents 363 that are radially formed about the axial hole 361. The vents 363 serve to allow air to be introduced into the worm wheel 350 when the first heat transfer plate 360 and the worm wheel 350 rotate, thereby increasing a cooling effect. The first heat transfer plate 360 may have a plurality of tooth protrusions 364 formed on the outer peripheral surface thereof. The tooth protrusions 364 are formed to correspond to the gear teeth of the tooth portion 352 of the worm wheel 350, so that heat is more rapidly transferred from the tooth portion 352. Meanwhile, since the tooth protrusions 364 overlap with the side of the tooth portion 352, it is possible to increase the strength of the tooth portion 352.

The first bearing 380 is disposed at one side of the worm wheel 350, and is coupled to the worm wheel shaft 340 to support the rotation of the worm wheel shaft 340. The first bearing 380 includes an inner ring 381 that is fastened to the worm wheel shaft 340 to integrally rotate when the worm wheel shaft 340 rotates, an outer ring 382 that is spaced apart from the inner ring 381, and a ball 383 disposed between the inner ring 381 and the outer ring 382. The inner ring 381 comes into contact with the contact protrusion 362 of the first heat transfer plate 360. For continuous contact between the inner ring 381 and the contact protrusion 362 when the worm wheel shaft 340 rotates, the inner ring 381 may have the same diameter as the contact protrusion 362. The outer ring 382 may be press-fitted to the worm wheel housing 320. The heat transferred from the contact protrusion 362 to the inner ring 381 is transferred to the worm wheel housing 320 through the outer ring 382, and is cooled in the worm wheel housing 320 having a relatively large surface area.

At the other side of the worm wheel 350, a second bearing 390 is coupled to the worm wheel shaft 340 to support the rotation of the worm wheel shaft 340. Since the configuration of the second bearing 390 is identical to that of the first bearing, detailed description thereof will be omitted.

The second heat transfer plate 370 may be further arranged on the second surface of the worm wheel 350 to further increase a heat dissipation effect. Since the second heat transfer plate 370 has a configuration similar to the first heat transfer plate, no description thereof will be separately given. However, the second heat transfer plate 370 is disposed between the worm wheel 350 and the second bearing 390, and has a contact protrusion 372, which comes into contact with the second surface of the worm wheel 350 and is formed around the axial hole while protruding toward the second bearing 390, so as to transfer heat generated by the worm wheel 350 to the second bearing 390. That is, the contact protrusion 362 of the first heat transfer plate 360 and the contact protrusion 372 of the second heat transfer plate 370 protrude in facing directions.

The reducer for an electronic power steering apparatus having the above configuration according to the embodiment of the present invention can rapidly radiate heat generated by the worm wheel to the outside of the gear housing when the motor, the worm shaft, and the worm wheel, which generate rotational force, are driven according to the control of an ECU that receives information on steering torque of a steering wheel by a driver, thereby preventing a general phenomenon due to accumulation of heat in the worm wheel.

This is according to the structural characteristic of the reducer that generates rotational force to assist steering by the control of the ECU, based on the information on steering torque of a steering wheel. The worm shaft that rotates at a high speed at the same speed as the motor and the worm wheel 350 that engages with the worm shaft and rotates along therewith have a reduction ratio of about 10:1 to 20:1 and a large load. In addition, the tooth portion 352 may be made of an engineering plastic material instead of metal in order to prevent occurrence of strange noise due to characteristics of the power steering apparatus.

The worm shaft and the worm wheel 350, to which a large load is applied at the time of high-speed rotation, generate heat when they are operated, and particularly the plastic material of the tooth portion 352 formed on the worm wheel 350, which engages with the worm shaft and rotates along therewith, is very vulnerable to heat. Therefore, the reducer according to the embodiment enables heat to be radiated out of the gear housing 300 through the first and second bearing 380 and 390 and the worm wheel shaft 340.

That is, the heat generated by the worm wheel 350, which engages with the worm shaft and rotates along therewith, is transferred to the first and second heat transfer plates 360 and 370, and is then transferred to the first and second bearing 380 and 390 through the contact protrusion 362 of the first heat transfer plate 360 and the contact protrusion 372 of the second heat transfer plate 370. Then, the heat is cooled by outside air while being transferred to the worm wheel housing 320 that is in contact with the first and second bearing 380 and 390.

In addition, a portion of the heat transferred to the first and second bearing 380 and 390 may be radiated out of the worm wheel housing 320 through the worm wheel shaft 340 that is coupled through the worm wheel housing 320.

As described above, the heat generated by the worm wheel 350 that engages with the worm shaft is radiated out of the worm wheel housing 320 through the bearings 380 and 390 and the worm wheel shaft 340 by means of the heat transfer plates 360 and 370. Therefore, it is possible to prevent heat from being accumulated in the worm wheel that has the tooth portion made of a plastic material, and thus to prevent a deterioration in the durability of the worm wheel.

As is apparent from the above description, according to exemplary embodiments of the present invention, heat generated by a worm wheel that engages with a worm shaft is radiated out of a worm wheel housing through bearings and a worm wheel shaft by means of heat transfer plates. Therefore, it is possible to prevent heat from being accumulated in the worm wheel that has a tooth portion made of a plastic material, and thus to prevent a deterioration in the durability of the worm wheel.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A reducer for an electronic power steering apparatus, comprising:
a gear housing comprising a worm shaft housing and a worm wheel housing;
a worm wheel shaft connected to a steering shaft to rotate along with rotation of the steering shaft;
a worm wheel accommodated in the worm wheel housing, and having a first surface and a second surface facing the first surface, the worm wheel shaft being coupled to the worm wheel;
a first heat transfer plate provided to come into contact with the first surface of the worm wheel; and
a first bearing coupled to the worm wheel shaft to come into contact with the first heat transfer plate, and having an outer peripheral surface coming into contact with the worm wheel housing.

2. The reducer according to claim 1, wherein the first heat transfer plate has an axial hole through which the worm wheel shaft is coupled to the first heat transfer plate, and the first heat transfer plate has a contact protrusion that is formed around the axial hole while protruding therefrom to come into contact with the first bearing.

3. The reducer according to claim 2, wherein the first heat transfer plate has a plurality of vents radially arranged about the axial hole.

4. The reducer according to claim 2, wherein the first bearing comprises an inner ring fastened to the worm wheel shaft and coming into contact with the contact protrusion of the first heat transfer plate, an outer ring spaced apart from the inner ring and coupled to the worm wheel housing, and a ball disposed between the inner ring and the outer ring.

5. The reducer according to claim 1, wherein the first heat transfer plate has a plurality of tooth protrusions that are formed on an outer peripheral surface thereof so as to correspond to gear teeth of the worm wheel.

6. The reducer according to claim 1, further comprising:
a second heat transfer plate provided to come into contact with the second surface of the worm wheel; and
a second bearing coupled to the worm wheel shaft to come into contact with the second heat transfer plate, and having an outer peripheral surface coming into contact with the worm wheel housing.

7. The reducer according to claim 1, wherein the worm wheel comprises a worm wheel body coupled with the worm wheel shaft, and a tooth portion formed on an outer peripheral surface of the worm wheel body, the tooth portion being formed with gear teeth so as to engage with a worm of a worm shaft.

8. The reducer according to claim 7, further comprising a plurality of heat transfer members interposed between the worm wheel body and the tooth portion, the heat transfer members coming into contact with the first heat transfer plate.

9. The reducer according to claim 7, wherein each of the worm wheel body and the tooth portion is made of an engineering plastic material.
